(19) United States
(12) Patent Application Publication
(10) Pub. No.: US 2018/0368599 A1
(43) Pub. Date: Dec. 27, 2018

(54) MULTIPURPOSE INTERCHANGEABLE DRINK RECEPTACLE WITH ELASTOMERIC STRAP

(71) Applicant: Roland Delobel, Henderson, NV (US)

(72) Inventor: Roland Delobel, Henderson, NV (US)

(21) Appl. No.: 15/635,172

(22) Filed: Jun. 27, 2017

(51) Int. Cl. A47G 23/02; F16B 2/08; F16M 13/02; A47C 7/70; F16B 1/00

(52) U.S. Cl. CPC A47G 23/02; F16B 2/08; F16B 2001/0028; A47C 7/70; F16B 1/00; F16M 13/022

(57) ABSTRACT

An interchange beverage holder comprising a stretchable strap adapted to circumscribe furniture and one or more receptacles adapted to receive and secure a beverage.

### BACKGROUND OF THE INVENTION

### Field of the Invention

This invention relates to a drink receptacle and more particularly relates to drink receptacle used in residential applications for holding one or more a drink container upright in an easily accessible position.

### Description of the Related Art

Individuals recreating or relaxing in residential settings, including those making use of indoor or outdoor seating, frequently find it useful and enjoyable to consume a beverage and seek means of easily accessing such beverages with minimal effort.

Cup holders often double as an insulating sleeve for keeping a beverage cool, are occasionally recessed into arm rests of chairs and couches, although most indoor and outdoor furniture does not provide integrated cup holders for securing drinks or refreshments. The prior art which teaches cup holders discloses trays, arm rests, and protruding receptacles with recessed apertures arranged often in a side-by-side configuration or front-to-back relation. Such devices are not adjustable and cannot be adapted for use with furniture not designed with integrated securement means. There are no apparati known in the art which are easily interchanged from one piece of furniture to another.

Thus, it is desirable to provide a compact beverage container holder which can be adapted for use with furniture of almost any size and shape and which can easily be adjusted to facilitate convenient access in arm's reach.

### SUMMARY OF THE INVENTION

From the foregoing discussion, it should be apparent that a need exists for an interchangeable adjustable beverage receptacle.

Beneficially, such a system would overcome many of the difficulties of the prior art by providing a cup holder easily interchangeable from one piece of furniture to another which allows a user to position a beverage in any easily accessible location around the circumference of the furniture.

The present invention has been developed in response to the present state of the art, and in particular, in response to the problems and needs in the art that have not yet been fully solved by currently available apparati and methods. Accordingly, the present invention has been developed to provide an interchangeable drink receptacle comprising: a stretchable, elongated, flexible elastomeric strap adapted to circumscribe an exterior surface of furniture, the strap having two distal ends; a connector for interconnecting the two distal ends to form an uninterrupted piece; and one or more cylindrical receptacle for securing a beverage affixed to the strap, the cylindrical receptacle having an open top end and a closed bottom end.

The cup holder may be tapered toward a bottom surface. The connector may comprise a snap fit closure. The connector may comprises Velcro. The one or more receptacles may be detachable affixable to the strap.

The one or more receptacles may hang from the strap using a downwardly-curving top member.

A second interchangeable drink receptacle comprising: an uninterrupted stretchable, elongated, flexible elastomeric strap adapted to circumscribe an exterior surface of furniture; a connector for interconnecting the two distal ends to form an uninterrupted piece; and a cylindrical receptacle for securing a beverage detachably affixable to the strap, the cylindrical receptacle having an open top end and a closed bottom end.

The cup holder may be tapered toward a bottom surface. The connector may comprise a snap fit closure. In various embodiments the connector comprises Velcro.

The one or more receptacles may be detachably affixable to the strap. The one or more receptacles may hang from the strap using a downwardly-curving top member.

A third interchangeable drink receptacle is provided comprising: an uninterrupted stretchable, elongated, flexible elastomeric strap adapted to circumscribe an exterior surface of furniture; a Velcro connector for interconnecting the two distal ends to form an uninterrupted piece; and a cylindrical receptacle for securing a beverage detachably affixable to the strap using a downwardly-curving top member, the cylindrical receptacle having an open top end and a closed bottom end.

The cup holder may be tapered toward a bottom surface.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a forward perspective view of an interchangeable drink receptacle with elastomeric strap in accordance with the present invention;

FIG. 2 is a forward perspective view of an interchangeable drink receptacle with elastomeric strap in accordance with the present invention;

FIG. 3 is a side perspective view of an interchangeable drink receptacle with elastomeric strap in accordance with the present invention;

FIG. 4 is an environmental side perspective view of an interchangeable drink receptacle with elastomeric strap in accordance with the present invention;

FIG. 5 is an environmental forward perspective view of an interchangeable drink receptacle with elastomeric strap in accordance with the present invention;

FIG. 6 is a side perspective view of an interchangeable drink receptacle with elastomeric strap in accordance with the present invention;

FIG. 7A is a forward perspective view of an interchangeable drink receptacle with elastomeric strap in accordance with the present invention;

FIG. 7B is a forward perspective view of an interchangeable drink receptacle with elastomeric strap in accordance with the present invention;

FIG. 7C is a forward perspective view of an interchangeable drink receptacle with elastomeric strap in accordance with the present invention; and

FIG. 8 is a forward perspective view of an interchangeable drink receptacle with elastomeric strap in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

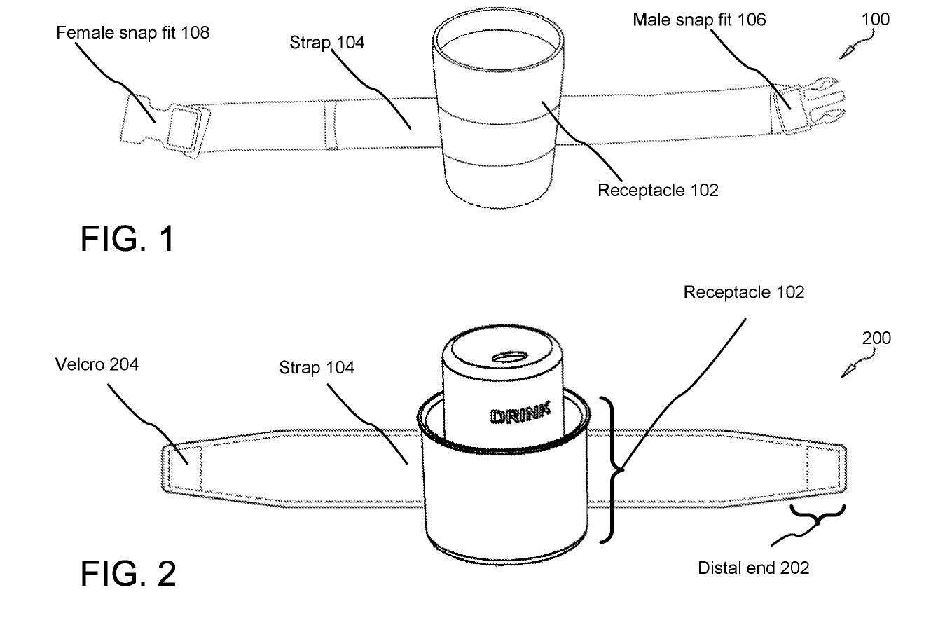

FIG. 1 is a forward perspective view of an interchangeable drink receptacle with elastomeric strap 100 in accordance with the present invention.

The device 100 preferably comprises a woven elastomeric strap 104 formed from a durable material such as nylon or polyester, although organic materials can be used such as cotton or leather. The strap 104 could also be formed as a one-piece molded strap. This strap 104 can have a width varying from about one half an inch to eight inches, and can be formed from a very flexible material.

In various embodiments, a cylindrical receptacle 102 is affixed to the strap 104. The receptacle 102 may be detachably affixed to the strap 104 using clips, buckets, other means known to those of skill in the art. In other embodiments, the device 100 comprises two straps 104 each affixed at a proximal end to the receptacle 102. In still further embodiments, the strap 104 circumscribes the exterior surface of the receptacle 102. The strap 104 may be fabricated from flexible, stretchable material.

The receptacle 102 comprises a hollow cylindrical enclosure with an open top end and a closed bottom end, the open top end for receiving a beverage. In various embodiments, the receptacle 102 is tapered toward its lower surface.

The strap 104, in some embodiments, comprises a first distal end 202 (shown below) that is joined, such as by a sewn seam, to a connector such as Velcro 204 or a snap fit 106, 108. The connector, as shown, is in the form of a snap fit 106, 108, but other shaped connectors could be used, and formed from any other strong material, including nylon, carbon fiber or even reinforced materials. Other connectors may include a buckle, a carabiner, and the like.

The strap 104 could be a continuous member which is uninterrupted without intervening connection means.

The snap fit closure 106, 108 comprises male and female portions 106, 108. The snap fit closure is a standard type of removable closure assembly that permits the male and female portions to be separated from one another. In addition, the strap 104 connections may adjustable to the straps 106, 108 to be shortened or lengthened as desired.

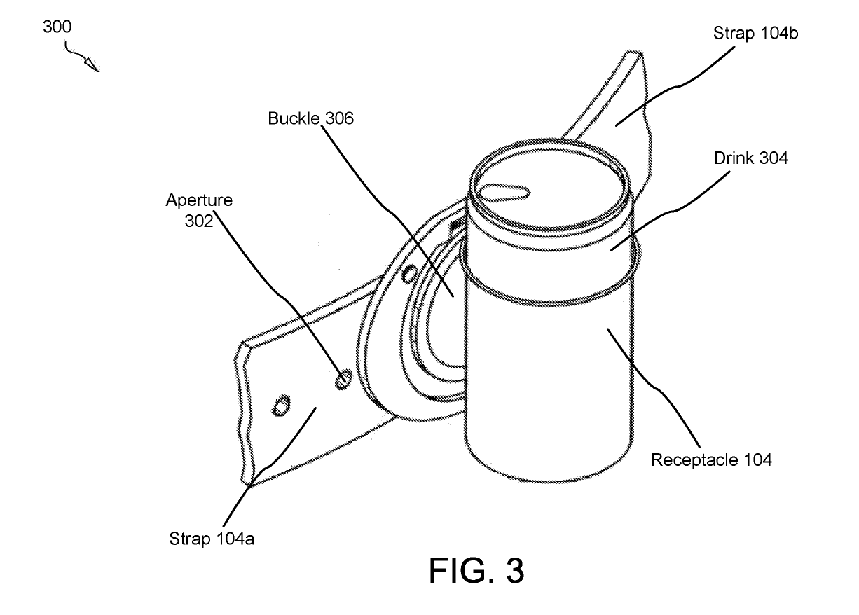

FIG. 2 is a forward perspective view of an interchangeable drink receptacle with elastomeric strap in accordance with the present invention.

The device 200 may comprise Velcro hook and loop fastener material 204 at a first distal end and second distal end.

The device 200 may be stretched to circumscribe a wide variety of structures and furniture including, but not limited, chairs, beds, couches, recliners, tables, stools, end tables, clocks, and the like.

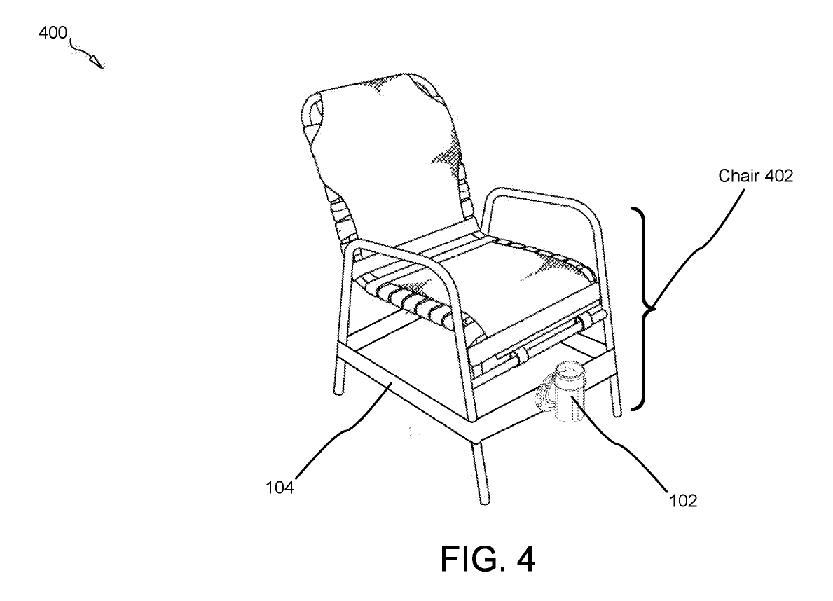

FIG. 3 is a side perspective view of an interchangeable drink receptacle with elastomeric strap 300 in accordance with the present invention.

The device 300 comprises a buckle 306 which interconnects a first strap 104a to a second strap 104b using means known to those of skill in the art. The receptacle 104 may affix around an item of furniture as further described and shown below.

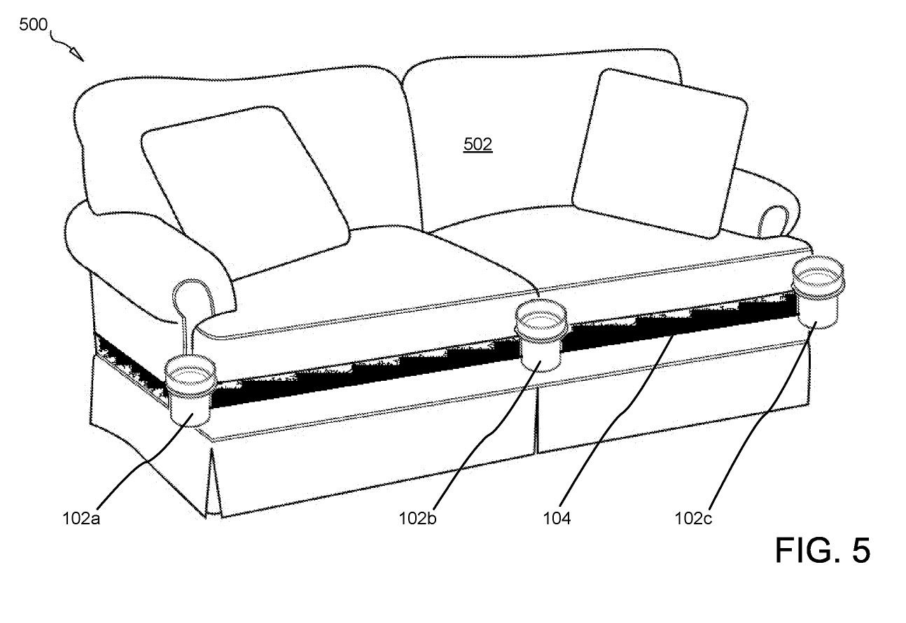

FIG. 4 is an environmental side perspective view of an interchangeable drink receptacle with elastomeric strap 400 in accordance with the present invention.

As shown, the strap 104 circumscribes the legs of a chair 402. The receptacle 102 adapted to receive a drink is disposed in front of the chair 402 where a received drink is easily accessible by a use of the chair 402.

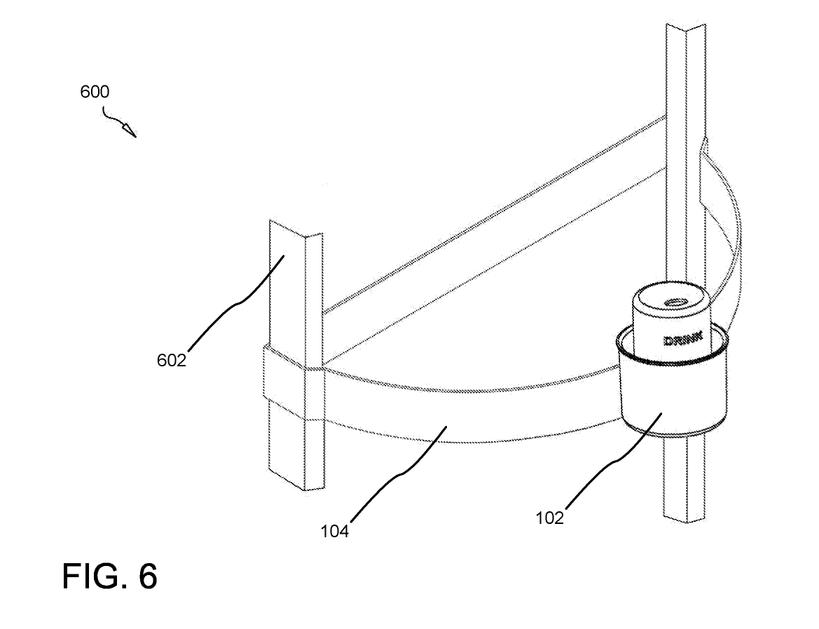

FIG. 5 is an environmental forward perspective view of an interchangeable drink receptacle with elastomeric strap 500 in accordance with the present invention.

As shown the couch 502 is circumscribed by a strap 104 affixed to a plurality of receptacle 102, each disposed in easy reach of individuals sitting in the couch 502.

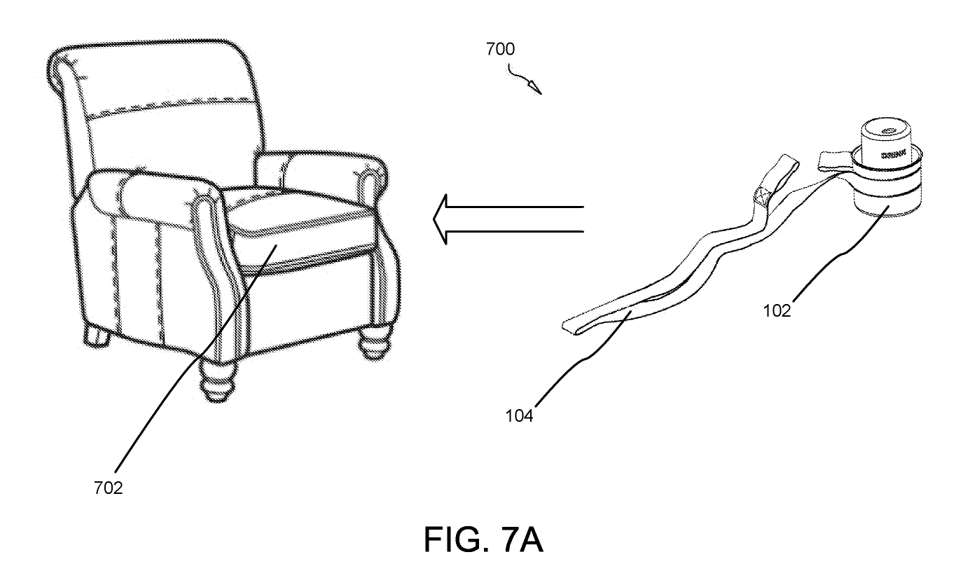

FIG. 6 is a side perspective view of an interchangeable drink receptacle with elastomeric strap 600 in accordance with the present invention.

As shown, the strap 104 is affixed around the legs 602.

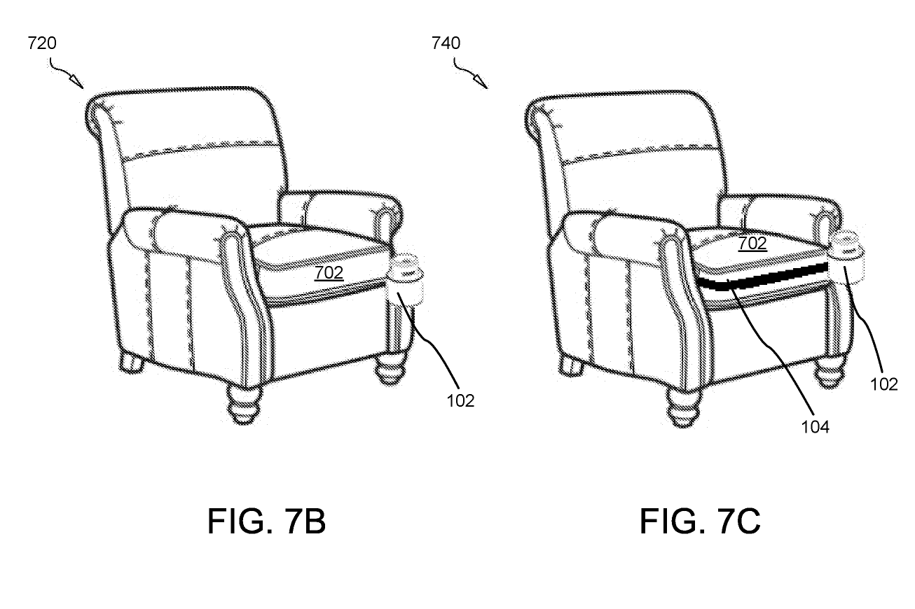

FIG. 7A is an environmental forward perspective view of an interchangeable drink receptacle with elastomeric strap in accordance with the present invention. In the shown embodiment, the device 700 inserts alongside or beneath a cushion 702 of a chair or sofa. The strap 104 does not need to be wrapped around the cushion itself, rather the strap 104 may position beneath or alongside the cushion and make use of the friction fit there created to secure the receptacle 102 and drink.

FIG. 7B is a forward perspective view of an interchangeable drink receptacle with elastomeric strap in accordance with the present invention.

In the shown embodiment, the receptacle 702 is suspended from the strap 104 and positions alongside the cushion 702 to create a friction fit.

The strap 104 may alternatively wrapped around the leg of a chair.

FIG. 7C is a forward perspective view of an interchangeable drink receptacle with elastomeric strap in accordance with the present invention.

The strap 104 in the shown embodiment circumscribes the cushion 702. The receptacle 102 positions along the forward side of the cushion 702.

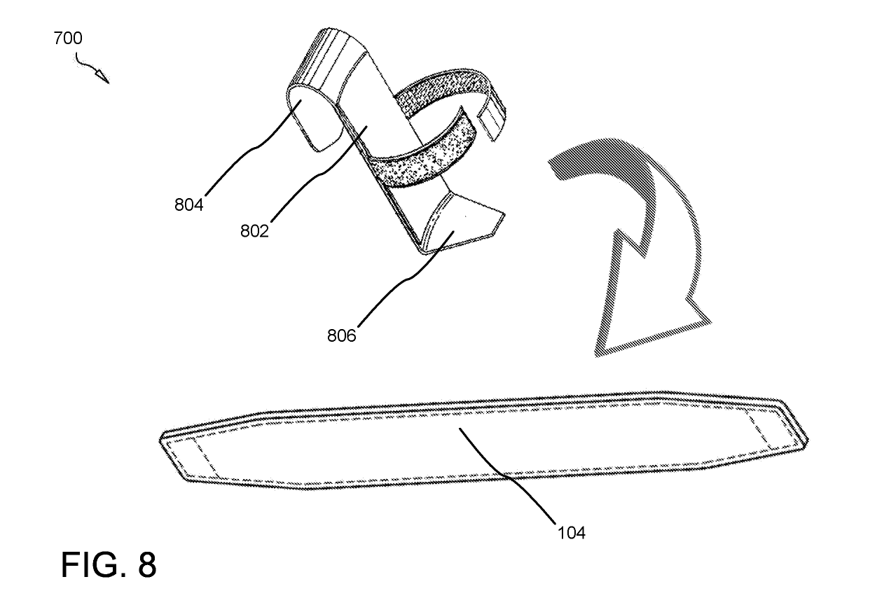

FIG. 8 is a forward perspective view of an interchangeable drink receptacle with elastomeric strap 800 in accordance with the present invention.

The device 800 is disassembled. The receptacle 802 in the shown embodiment is detachably affixable to the strap 104 and adapted to hang using a hook integrated in the receptacle from the strap 104. The receptacle 802 comprises a downwardly-curved upper arm 804 and inwardly-curved arms 806 for securing a beverage in place for easy access of a user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An interchangeable drink receptacle comprising:
a continuous, uninterrupted stretchable, elongated, flexible elastomeric strap adapted to circumscribe an exterior surface of furniture;
one or more cylindrical receptacle for securing a beverage affixed to the strap, the cylindrical receptacle having an open top end and a closed bottom end, the cylindrical receptacle detachably interconnected with a connector to the strap
wherein the strap circumscribes an exterior surface of the receptacle.

2. The apparatus of claim 1, wherein the cylindrical receptacle is tapered toward a bottom surface.

3. The apparatus of claim 1, wherein the connector comprises a snap fit closure.

4. The apparatus of claim 1, wherein the connector comprises Velcro.

5. The apparatus of claim 4, wherein the one or more receptacles are detachable affixable to the strap using a hook adapted to hang the one or more receptacles from the strap.

6. The apparatus of claim 1, wherein the one or more receptacles hang from the strap using a downwardly-curving top member.

7. An interchangeable drink receptacle comprising:
an uninterrupted stretchable, elongated, flexible elastomeric strap adapted to circumscribe an exterior surface of furniture;
a connector for interconnecting the two distal ends to form an uninterrupted piece; and
a cylindrical receptacle for securing a beverage detachably affixable to the strap, the cylindrical receptacle having an open top end and a closed bottom end.

8. The apparatus of claim 7, wherein the cup holder is tapered toward a bottom surface.

9. The apparatus of claim 7, wherein the connector comprises a snap fit closure.

10. The apparatus of claim 7, wherein the connector comprises Velcro.

11. The apparatus of claim 10, wherein the one or more receptacles are detachable affixable to the strap.

12. The apparatus of claim 7, wherein the one or more receptacles hang from the strap using a downwardly-curving top member.

13. (canceled)

14. (canceled)
